(19) United States
(12) Patent Application Publication
(10) Pub. No.: US 2013/0216938 A1
(43) Pub. Date: Aug. 22, 2013

(54) CO2 TOLERANT, MIXED CONDUCTIVE OXIDE AND USES THEREOF FOR HYDROGEN SEPARATION

(71) Applicants: Wilhelm Albert Meulenberg, AA Vijlen (NL); Mariya Ivanova, Julich (DE); Hans Peter Buchkremer, Heinsberg (DE); Detlev Stoever, Niederzier (DE); Jose Manuel Serra Alfaro, Valencia (ES); Sonia Escolastico, Valencia (ES)

(72) Inventors: Wilhelm Albert Meulenberg, AA Vijlen (NL); Mariya Ivanova, Julich (DE); Hans Peter Buchkremer, Heinsberg (DE); Detlev Stoever, Niederzier (DE); Jose Manuel Serra Alfaro, Valencia (ES); Sonia Escolastico, Valencia (ES)

(73) Assignees: UNIVERSIDAD POLITECNICA DE VALENCIA, 46022 VALENCIA (ES); FORSCHUNGSZENTRUM JULICH GMBH, 52425 JULICH (DE)

(21) Appl. No.: 13/810,296

(22) PCT Filed: Jun. 28, 2011
(86) PCT No.: PCT/EP11/60832

§ 371 Date: Mar. 27, 2013

(30) Foreign Application Priority Data
Jul. 19, 2010 (DE) 10 2010 027645.6

(51) Int. Cl. H01M 8/10; B01D 53/22

(52) U.S. Cl. CPC H01M 8/1016; B01D 53/228
USPC 429/495; 96/4; 252/519.15; 252/519.1

(57) ABSTRACT

The material according to the invention is based on a material having the composition Ln₆WO₁₂ with a defect fluorite structure in which the cations, at least partially, have been substituted in a defined manner in the A and/or B position. It has the following composition:

Ln₁₋ₓAₓ)₆(W_{1-y}B_{y})_{z}O_{12-δ}

where
Ln=an element from the group (La, Pr, Nd, Sm),
A=at least one element from the group
   (La, Ce, Pr, Nd, Eu, Gd, Tb, Er, Yb, Ca, Mg, Sr, Ba, Th, In, Pb),
B=at least one element from the group (Mo, Re, U, Cr, Nb),
0≦x≦0.7 and 0≦y≦0.5, wherein, however, either x or y>0,
1.00≦z≦1.25 and 0≦δ≦0.3.

The mixed proton-electron conducting material exhibits an improved mixed conductivity, good chemical stability as well as good sintering properties, and can be used in particular as a material for a hydrogen-separating membrane or as a electrolyte at higher temperatures.

The invention relates to a CO₂-tolerant, mixed conductive oxide, which is suitable in particular for use as a membrane for hydrogen separation or as a fuel cell electrode even at high temperatures.

### PRIOR ART

Dense oxide ceramics which have a conductivity for both protons as well as for electrons are referred to as mixed protonic electronic conductors (MPEC).

MPEC materials are known from many areas of material technology and are used, for example, in the production of dense ceramic materials. Membranes of this type can be used, for example, as a solid electrolyte in a proton-conducting solid oxide fuel cell (PC-SOFC), as an electrode component in a proton-conducting solid oxide fuel cell irrespective of the electrolyte type, in systems for selective gas separation, particularly hydrogen separation, or also in petrochemistry.

If a partial pressure difference is applied to both sides of such an MPEC membrane, a transport of protons and electrons in the same direction occurs at the same time. This transport principle in solid matter offers some advantages in the practical application of such membranes in various processes.

Apart from the application in a membrane reactor, for example for a partial hydrogenation by controlled hydrogen supply, a novel and innovative field of application is opened up in the area of the pre-combustion power plants in which the CO₂ separation concept is implemented. High-purity hydrogen which can be used directly, for example, in fuel cells or vehicles, can be generated effectively by means of this technology. At the same time, a CO₂ separation is made possible in these concepts which is considered one of the greatest challenges in the area of environmental technology.

The pre-combustion concept comprises several process stages, in particular the partial oxidation of a fossil fuel (methane, natural gas or coal) to form synthesis gas (CO+H₂), the water-gas shift reaction (WGS), by means of which the CO proportion is minimized while the H₂ proportion is increased in a synthesis gas, and the CO₂/H₂ separation by means of a MPEC membrane.

If one side of such a dense ceramic membrane is exposed to an atmosphere comprising water vapor, then protons are generated by the dissociative adsorption of the water, followed by the Kröger-Vinck reaction:

H₂O+V₀..+O_{O}^{x}→2OH₀. (Eq. 1)
Thus, the presence of oxygen vacancies that are hydrated by the reaction plays an important role for the implementation of protons in the oxide crystal lattice.

The dissociative adsorption of water on the membrane in this case comprises the following partial steps: a) water molecules are split into hydroxyl groups (OH⁻) and protons (H⁺), b) the hydroxyl groups (OH⁻) absorb on oxygen ion vacancies (V₀..) that have a double positive charge, c) protonation of the lattice oxide ions. Because no free electrons are generated during this process, the membrane, which mainly acts as a proton conductor, can advantageously be operated under wet conditions. This property makes such a membrane attractive, for example, for application as a dense electrolyte in a PC-SOFC.

If one side of such a dense ceramic membrane is exposed to a hydrogen-rich atmosphere, then, in addition to the generation of protons, free electrons are also generated by the hydrogen oxidation reaction

H₂→2H.+2e′ (Eq. 2)
These protons are then incorporated into the oxide lattice by them protonating the lattice oxide ions.

The protons in the structure are also referred to as interstitial vacancies (Hᵢ.), even though their positions are not located at proper interstitial positions but in the electron cloud of the “guest” oxide ion.

In a mixed proton-electron conducting material, both the protons as well as the electrons are charge carriers and thus contribute to the total conductivity of the material. The total conductivity σₜₒₜ in this case is composed of the contributions of the proton conductivity σ_{H+} and the electronic conductivity σₑ, where:

σₜₒₜ=σ_{H+}+σₑ₋ (Eq. 3)

Just like the ionic conductivity, the total conductivity of the material can be measured directly.

The electronic conductivity can thus be calculated by subtracting the ionic conductivity from the total conductivity.

The so-called transport number t is introduced in order to describe the partial conductivities of a material. This transport number can be determined for every charge carrier.

The transport numbers for protons and electrons are defined as:

$${t}_{H +} = \frac{{σ}_{H +}}{{σ}_{tot}} \\ and \\ {t}_{e -} = \frac{{σ}_{e -}}{{σ}_{tot}} \qquad ( Eq . 4 )$$

In this case, the conductivity of protons is proportional to their charge z, their concentration c, their mobility μ as well as to their diffusion coefficient D:

$${σ}_{{H}^{+}} = {zFc}_{{H}^{+}} {μ}_{{H}^{+}} = \frac{{z}^{2} {Fc}_{{H}^{+}} {D}_{{H}^{+}}}{kT} \qquad ( Eq . 5 )$$

In order to satisfy the requirement of electric neutrality, electrons or electron vacancies have to be created additionally in the crystal lattice. Electrons and the protons move in the same direction.

The permeation of hydrogen through a dense ceramic membrane is proportional to the “ambivalent” conductivity, with the proton conductivity σ_{H+} now being set instead of the ionic conductivity σᵢ. Thus, the flux density of the protons through a membrane can be represented as follows:

$${j}_{{H}^{+}} = \frac{- RT}{2 {F}^{2} L} {\int }_{I}^{II} {σ}_{{H}^{+}} {t}_{e} d ln {p}_{{H}_{2}} \qquad ( Eq . 6 )$$

Due to the partial pressure gradient over the MPEC membrane, the protons generated by the hydrogen oxidation reaction move through the membrane in the same direction as the protons. In the process, they combine into hydrogen, H₂, on the side of the membrane that has the lower hydrogen partial pressure.

In the two above-mentioned cases the protons move within the structures of the membranes mainly by means of jumps between the stationary “guest” oxide ions (Grotthuss mechanism). The second case is important for the mode of operation of an MPEC membrane.

The majority of the currently investigated MPEC materials have the perovskite structure (ABO₃), but also fluorites (AO₂), brownmillerites (A₂B₂O₅) or pyrochlores (A₂B₂O₇) are currently being investigated. In the case of the perovskites, compositions of the form A′A″BO₃ as well as of the form A₂B′B″O₆ and A₃B′B″O₉ occur.

Examples for the chemical compositions of such complex perovskites for improved oxygen transport include La₁₋ₓSrₓCo0₃, Nd₁₋ₓSrₓCo0₃, Nd₁₋ₓCaₓCo0₃ or La₁₋ₓSrₓNi0₃. La₁₋ₓ(Ca,Sr,Ba)ₓCo_{1-y}Fe_{y}O_{3-δ} and Ba(Sr)Co₁₋ₓFeₓO_{3-d} are mentioned in the literature as examples for MPEC materials with a high oxygen flux but low stability. In contrast, Sr(Ba)Ti(Zr)_{1-x-y}Co_{y}FeₓO_{3-δ} and La₁₋ₓSrₓGa_{1-y}Fe_{y}O_{3-δ} are mentioned as MPEC materials with a high stability, but low oxygen flux.

Moreover, mention must be made of SrCeO₃, BaCeO₃, SrZrO₃ as the best-investigated MPEC materials with a perovskite structure that are suitable for high-temperature use. Cerates and zirconates are currently state of the art as MPEC materials and exhibit the highest proton conductivities in oxidic systems.

A very well-investigated class of the mixed proton and electron conductors includes the partially substituted perovskites, such as for example CaZrO₃, SrCeO₃ and BaCeO₃, in which the substitution of cerium or zirconium by trivalent cations causes oxygen vacancies and other charge defects and thus leads to a mixed conductivity in gas mixtures comprising oxygen, hydrogen and water vapor. From US 2006/015767 A1, for example, perovskite-based membranes for hydrogen separation are known, which comprise, for example BaCe_{0.9-x}Y_{0.1}RuₓO₃₋ₐ or SrZr_{0.9}Y_{0.1}RuₓO_{3-α} or SrCe_{0.9-x}RuₓO_{3-α} where respectively x=0.05 to 0.8.

In recent years, mixed conducting ceramics have already been intensively investigated with regard to their suitability as a membrane for oxygen separation. Therefore, it was obvious to assume that dense ceramic materials consisting of a mixed proton and electron conductor could also be suitable as a simple and effective means for the separation of hydrogen from waste gases.

In addition to the materials present in the perovskite-structure, a multitude of other material classes were therefore investigated with regard to their suitability as a gas separation membrane for an H₂ separation. Among them are materials with a fluorite, pyrochlore, brownmillerite or even fergusonite structure.

In order to be suitable as a membrane for hydrogen separation, it is necessary for the membrane material to have a sufficient proton and electron conductivity in order thus to provide a high degree of permeability and selectivity for hydrogen. In addition, such a material should, however, also have a high degree of catalytic activity for the oxidation and formation of hydrogen on the interface solid/gaseous. For example, dense BaCe_{0.8}Y_{0.2}O₃ ceramics have a high hydrogen permeation rate.

High-temperature membranes for hydrogen separation enable the implementation of precombustion strategies in power plants, so that CO₂ and hydrogen can be separated in accordance with the shift reaction, thus generating a waste gas flow of moist CO₂, which can be easily liquefied and stored. In addition, hydrogen membranes can be used at high temperatures in water-gas shift reactors, e.g. in IGCC power plants (=Integrated Gasification Combined Cycle), and in hydrocarbon reformation reactors.

High-temperature membranes for hydrogen separation as a rule are based on two types of membrane: on the one hand, the hydrogen-permeable metals, such as, for example, palladium alloys or Nb/Ta/V, or, on the other hand, the mixed proton and electron conducting oxides that are stable at high temperatures in a hydrogen atmosphere. Typical operating conditions include temperatures of between 400 and 900° C., pressures 2 between 50 bar as well as an environment that can have very high concentrations of water and CO₂, as well as low concentrations of H₂S (typically 5 to 200 ppm).

However, the membranes for hydrogen separation using hydrogen-permeable metals known so far have some drawbacks. For example, the operation is generally limited to temperatures below 450° C. The metallic membranes are not cheap, particularly if Pd is used. The chemical resistance of the metals, primarily regarding H₂S, which disadvantageously leads to thermodynamically stable sulfide compounds, is low. Other metals, such as Nb, V or Ta oxidize already at moderate temperatures of up to 300° C. if coming into contact with oxygen.

In the membranes for hydrogen separation consisting of mixed proton and electron conducting oxides (cerates and zirconates) that were known until now, the particularly low chemical and mechanical stability under reducing conditions as they are present in the operation for hydrogen separation, has proved to be disadvantageous. In addition, the high grain boundary resistance and the high production temperatures also lead to a limitation in the practical application of these perovskites.

The aim of the material development was to obtain defect centers for a high oxygen ion and electron conduction by means of substitution in the A and/or B position in the perovskite structure ABO₃ with cations of a lower valence.

Among the various proton-conducting oxides that remain stable also in CO2-containing atmospheres, investigations on Ln₆WO₁₂, where Ln=La, Nd, Gd and Er, were carried out by Shimura [1] and later also by Haugsrud [2]. For non-doped La₆WO₁₂ a proton conductivity for moist hydrogen was measured of maximally 3 to 5*10⁻³ S/cm at 850° C. and 5*10⁻³ S/cm at 900° C. In the case of the calcium-doped materials, which were also investigated, the result for low temperatures in the systems with Gd₆W₁O₁₂ and Er₆WO₁₂ was an increase of the ionic conductivity, however, not for reducing conditions around 900° C. At high temperatures and high partial pressures of oxygen or hydrogen, the electronic conductivity dominates for all materials. The investigations indicated the trend that the defect situation in which the Ca_{Ln-} acceptors are charge-compensated by oxygen vacancies and/or protons is predominant. In the case of moist hydrogen, below 900° C., the limiting factor appears to be the electronic conductivity, whereas above 900° C., the electronic conductivity is clearly predominant, but in return the ionic conductivity has a limiting effect.

As an alternative to the basic material La_{5.8}WO_{11.7} two materials which were doped in the A position and had a smaller ion radius than La³⁺ were investigated by Shimura [1], namely (La_{0.93}Zr_{0.06})_{5.8}WO_{11.9} and (La_{0.9}Nd_{0.1})_{5.8}WO_{11.7}.

Whereas a partial substitution of the lanthanum by Ca led to a phase separation, the Zr or Nd doped samples were present in a single phase. Above 800° C., the doped materials showed a lower electrical conductivity than the basic material La_{5.8}WO_{11.7}.

Moreover, Yoshimura et al. [3] investigated the electrical conductivity of the pseudo-binary system CeO₂—La₆WO₁₂. At about 90 mol-% CeO₂, the maximum conductivity was determined to be 1.1*10⁻³ S/cm at 500° C. and 4.4*10⁻³ S/cm at 600° C. The lowest value for the conductivity was found in a composition with 10 mol-% CeO₂.

### OBJECT AND SOLUTION

It is the object of the invention to provide a material for a high-temperature membrane for separating hydrogen which overcomes at least some of the above-listed drawbacks from the prior art. Furthermore, it is the object of the invention to provide a method for preparing such a material.

The objects of the invention are achieved by a material according to the main claim and by a preparation method according to the independent claim. Advantageous embodiments of the material as well as of the preparation method are apparent from the claims that respectively refer to them.

### DESCRIPTION OF THE INVENTION

Dense oxidic ceramics with conduction of both oxygen ions as well as electrons are referred to as mixed conductive (mixed protonic electronic conductor=MPEC). Intrinsically, an MPEC material exhibits both ion-conducting, in particular oxygen ion-conducting or proton-conducting properties, as well as electron-conducting properties which are typically on the same order of magnitude or differ maximally by about one order of magnitude.

Within the context of the invention, an oxide material with an improved mixed conductivity, improved chemical stability as well as improved sintering properties was found, which can in particular be used as a material for a hydrogen-separating membrane at higher temperatures.

The material according to the invention is based on a material having the composition Ln₆WO₁₂, where Ln=(La bis Lu), with a defect fluorite structure in which advantageous properties can be attained by a defined substitution of the cations in the A and/or B position.

In the material according to the invention, the lanthanide metal in the A position is partially replaced by at least one other metal with a similar ion radius and an oxidation state of between +2 and +4. Apart from metals from the same period (La to Lu), Ca, Mg, Sr, Ba, Th, In or Pb are also particularly suitable as substitution elements.

Additionally or alternatively, the tungsten metal cation in the B position is partially replaced by at least one other metal element with a similar ion radius and an oxidation state of between +4 and +6.

According to the invention, the mixed conductive material has the following composition (in the water-free state)

(Ln₁₋ₓAₓ)₆(W_{1-y}B_{y})_{z}O_{12-δ}

where
Ln=element from the group (La, Pr, Nd, Sm),
A=at least one element from the group (La, Ce, Pr, Nd, Eu, Gd, Tb, Er, Yb, Ca, Mg, Sr, Ba, Th, In, Pb),
B=at least one element from the group (Mo, Re, U, Cr, Nb),
0≦x≦0.5 and 0≦y≦0.5, wherein, however, either x or y>0,
and 1.00≦z≦1.25 and 0≦d≦0.3.

Depending on the chosen composition of the metal cations in the material, i.e. the substitution at the A and/or B position, a stoichiometric deviation δ of up to 0.3 may result for the oxygen. If a substitution by more than one cation occurs in the A or B position, the indices x and y respectively apply for the sum of the respective substitution elements.

All materials according to the invention have a single-phase structure based on a fluorite structure. In the process, the materials according to the invention can be prepared in different ways.
a) Complexing-jellification of the metal cations in an aqueous solution with an organic solvent and final calcination/tempering in air at temperatures between 1100° C. and 1600° C., depending on the material;
b) Freezing an aqueous solution comprising the metal cations with a complex-forming reactant, drying in a vacuum and final calcination/tempering in air at temperatures between 1100° C. and 1600° C., depending on the material;
c) Mixing of solid precursors (oxides, carbonates, acetates, etc.) of the various metals, followed by a thermal treatment at temperatures between 1100° C. and 1600° C., depending on the material;
d) Spray drying or electrospray ionization of stabilized liquid solutions comprising different metal cations, followed by a thermal treatment at temperatures between 1100° C. and 1600° C., depending on the material;
e) Precipitation of a liquid solution in which the different metal cations are present in a dissolved form, drying and final calcination/tempering in air at temperatures between 1100° C. and 1600° C., depending on the material.

According to claim 1, 0≦x≦0.7 is allowed in the case of the material according to the invention, the range of 0≦x≦0.5 having proved to be advantageous.

As special embodiments of the MPEC materials according to the invention, mention can be made, for example, of those having the general formula (Ln₁₋ₓAₓ)₆W_{z}O_{12-δ}, where x>0 and y=0. These are embodiments in which a substitution is provided only in the A position.

A special embodiment of the mixed proton-electron conducting material having a substitution in the A position has the composition (Ln₅A)₆W_{z}O_{12-δ}, in which x is selected to be x=1.

In another special embodiment of the mixed proton-electron conducting material having the composition (Ln₁₋ₓAₓ)₆W_{1.1}O_{12-δ}, z is selected to be z=1.1.

In this case, particularly advantageous embodiments of the material have as Ln=lanthanum or neodymium.

Furthermore, materials having the general formula Ln₆(W_{1-y}B_{y})_{z}O_{12-δ} have proved to be particularly suitable. These are embodiments in which a substitution is provided only in the B position, i.e. x is selected to be x=0 and y>0.

Furthermore, materials according to the invention having the general formula Ln₅A(W_{1-y}B_{y})_{z}O_{12-δ} have proved to be advantageous. These are embodiments which are doped in the A position with a proportion of x=1 and in which a substitution of the B position is provided.

Also in this case, particularly those materials have proved to be suitable which have as Ln=lanthanum and or neodymium, and which, additionally, again have lanthanum as the A position substitution. Other advantageous compositions are apparent from the special part of the description in which the positive properties are illustrated in more detail with reference to test results.

Though a 10% surplus of tungsten or B position cations was used in the preparation of the material samples in most of the investigated cases, the material according to the invention is not limited thereto. The surplus in the preparation is only supposed to ensure the single-phase property of the material.

The improvement of the proton conductivity in the materials according to the invention is attained in particular by a modification of the structure, the ion arrangement or the number or arrangement of the oxygen vacancies being attained, compared to Ln₆WO₁₂, by means of the above-mentioned substitutions in the A and or B position. Under usual operating conditions, these modifications as a rule have an influence on the concentration and the stability as well as on the mobility of the protons in the oxide material in the hydrated state. The usual operating conditions, such as they are provided for example in simulations for IGCC processes, are to be understood to be the following: Temperatures between 400 and 1000° C., pressures between 1 and 50 bars, water content between 0.3 and 50% as well as an atmosphere comprising 5-50% H₂, 5-50% CO₂ and 5-200 ppm H₂S.

The improvement of the electronic conductivity is attained, on the one hand, by the modified structure, but in particular by cations with different oxidation states being incorporated by the substitution. Though these cations, in principle, fit well into the given structure and are capable of partially changing the oxidation state under controlled conditions, but not up to the complete reduction down to metal. Despite this modification of the oxidation state of the substituted cations, this does not lead to large-scale structural modifications within the oxide material, i.e. to large-scale symmetry or structural modifications or great chemical expansion. In this case, chemical expansion is understood to be the effect that the change of the oxidation state of the different metal cations can lead to an increased ion radius which expands the crystal lattice. The effect is usually caused by a temperature change or a change in the surrounding atmosphere. The oxidation, or the reduction of the cation, which underlies the change of the oxidation state, must in this case proceed in a reversible manner. The change of the oxidation state advantageously leads to a reduction of the band gap, i.e. the energetic distance between the valence band and the conduction band of the material, and thus also to an increase in the electronic conductivity.

Due to its properties, the above-mentioned material according to the invention has special advantages when used as a crystalline and gas-tight, hydrogen-permeable membrane for separating hydrogen at higher temperatures, in particular in a power plant, or also as an electrolyte in an SOFC fuel cell. However, particularly advantageous compositions, such as, for example Nd₆W_{0.6}Re_{0.5}O_{12-δ}, show their advantages already at moderate temperatures of around 800° C.

### Special Part of the Description

The invention will be explained in more detail with reference to some experimental data (tables) and Figures; this is not supposed to limit the scope of protection.

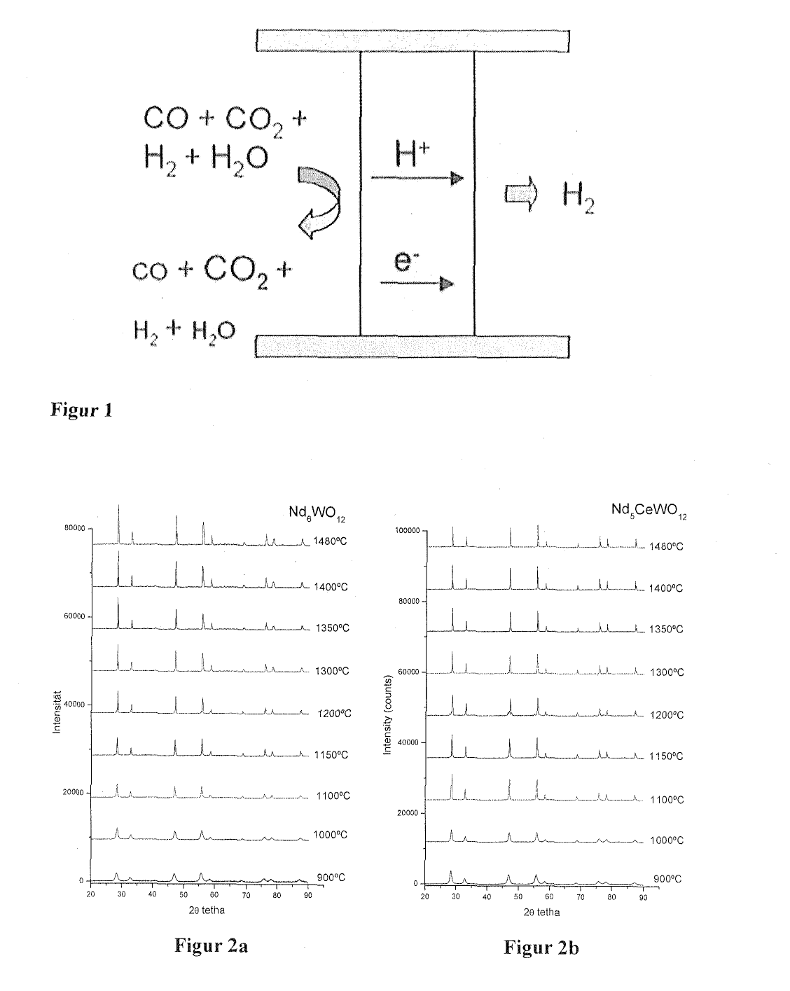

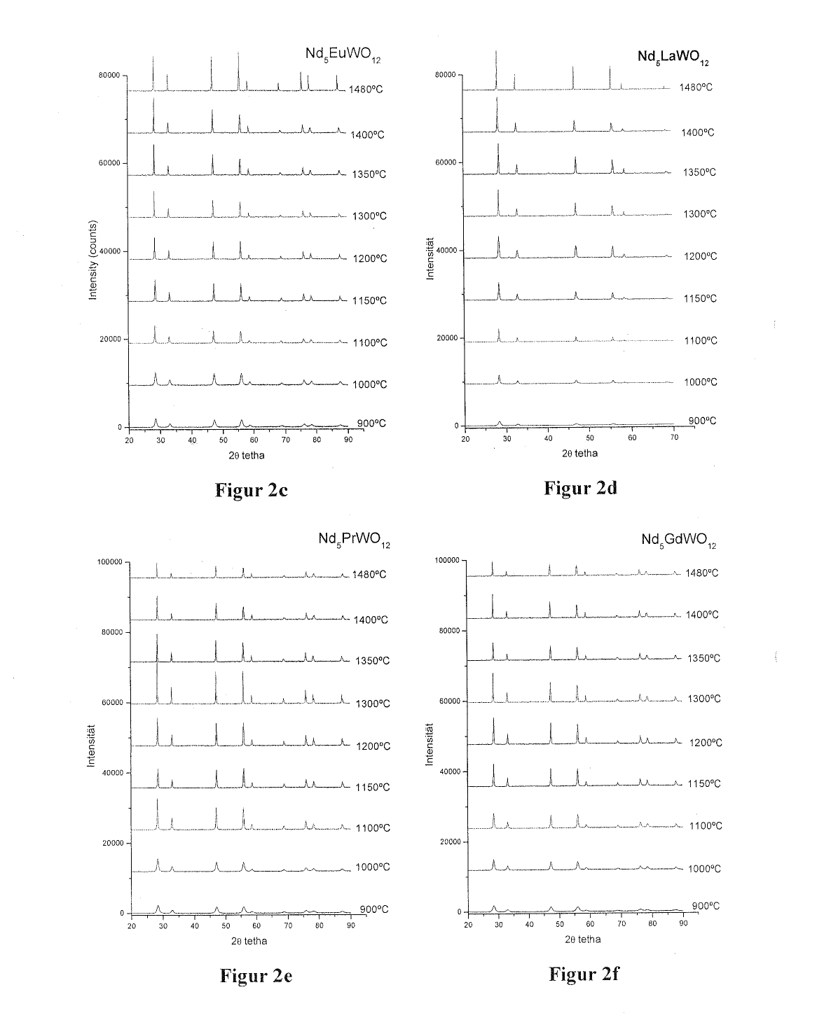

FIG. 1 schematically explains the process of hydrogen separation in a water-gas shift reactor. In the water-gas shift reaction, the CO proportion in a synthesis gas is minimized while the H₂ proportion is increased at the same time.

CO+H₂O [symbol] CO₂+H₂ΔH_{R298}⁰=−41.2 kJ/mol

With water vapor being added, CO reacts in a slightly exothermic manner to form CO₂ and H₂. Hydrogen is continuously separated from the gas mixture and thus the reaction is shifted to the right-hand side by means of a selective membrane, particularly by means of an MPEP membrane.

In the crystallized mixed proton-electron conducting membrane according to the invention, molecular hydrogen is dissociatively adsorbed on the hydrogen-rich side of the membrane and enters the oxide material of the MPEC membrane as a proton while donating an electron. On the reaction side, where a lower hydrogen partial pressure prevails, the protons recombine to form molecular hydrogen and are released into the gas phase.

### A. Preparation of MPEC Materials by Sol-Gel Technique

The preparation method applied here is based on a modified citrate complex formation for obtaining stable tungsten-containing and lanthanum-containing ions in the solution. The lanthanum oxides (e.g. Nd₂0₃, purity 99.9%) are dissolved in stoichiometric amounts in concentrated hot nitric acid (65 vol %) and the nitrate thus produced is complexed with citric acid at a mole ratio of 1:2 (cation charge to citric acid). Another solution is prepared for the B position ions (purity>99.5%), with ammonium tungstate, ammonium heptamolybdate or uranyl nitrate being used, and which are also complexed with citric acid (Fluka 99.5%) at the same mole ratio. In both cases, the metal complexing process is enhanced by a heat treatment for 1 hour at 120° C. Both solutions are then neutralized by controlled addition of ammonium hydroxide (32% by wt.) and mixed at room temperature (20 to 25° C.). The solution thus produced is then progressively concentrated by gradual heating up to 150° with stirring, and then foamed, i.e. polymerized, and the foam produced is then dried. The product produced in this manner is subsequently calcinated in air in order to extract carbon contaminations and promote the crystallization of the mixed oxide. The crystallized material is heated up to 1150 or 1350° C.

Attention should be paid to the fact that, in order to achieve phase stability with certainty, the preparation was carried out with a 10% surplus of tungsten, which is correspondingly taken into account below with the parameter z. The ratio of the A position cations to the B position cations was always selected to be 6:1.1.

In this way, the following materials, for example, were prepared.

Group A: with substitution in the A position (general formula: Ln₅AW_{1.1}O_{12-δ}), where x=1, y=0, z=1.1, and where Ln=La or Nd and A=(La, Nd, Ce, Pr, Nd, Sm, Eu, Gd, Tb, Yb).

In particular:

| | | | |
|---|---|---|---|
| Nd₆W_{1.1}O_{12-δ}, | Nd₅LaW_{1.1}O_{12-δ}, | Nd₅CeW_{1.1}O_{12-δ}, | Nd₅PrW_{1.1}O₁₂₋ |
| Nd₅SmW_{1.1}O_{12-δ}, | Nd₅EuW_{1.1}O_{12-δ}, | Nd₅GdW_{1.1}O_{12-δ}, | Nd₅TbW_{1.1}O₁₂₋ |
| Nd₅YbW_{1.1}O_{12-δ,} | La₅EuW_{1.1}O_{12-δ}, | La₅CeW_{1.1}O_{12-δ}, and | La₅TbW_{1.1}O_{12-δ}. |

Group B: with substitution in the B position (general formula: Ln₆(W_{1-y}B_{y})_{1.1}O_{12-δ}), where x=0, y=0.455 or 0.091, z=1.1, and where Ln=La or Nd and B=(Mo, Re, U, Cr, Nb).

In particular:

| | | | |
|---|---|---|---|
| Nd₆W_{1.1}Mo_{0.1}O_{12-δ}, | Nd₆W_{0.6}Mo_{0.5}O_{12-δ}, | Nd₆WRe_{0.1}O_{12-δ}, | Nd₆W_{0.6}Re_{0.5}O_{12-δ}, |
| Nd₆WU_{0.1}O_{12-δ}, | Nd₆W_{0.6}U_{0.5}O_{12-δ,} | Nd₆WCr_{0.1}O_{12-δ}, | Nd₆W_{0.6}Cr_{0.5}O_{12-δ}, |
| Nd₆WNb_{0.1}O_{12-δ}, | Nd₆W_{0.6}Nb_{0.5}O_{12-δ}, | and | |
| La₆WMo_{0.1}O_{12-δ}, | La₆W_{0.6}Mo_{0.5}O_{12-δ}, | La₆WRe_{0.1}O_{12-δ}, | La₆W_{0.6}Re_{0.5}O_{12-δ}, |
| La₆WU_{0.1}O_{12-δ}, | La₆W_{0.6}U_{0.5}O_{12-δ,} | La₆WCr_{0.1}O_{12-δ}, | La₆W_{0.6}Cr_{0.5}O_{12-δ}, |
| La₆WNb_{0.1}O_{12-δ} and | La₆W_{0.6}Nb_{0.5}O_{12-δ.} | | |

As the third group, materials according to the invention were prepared in which a substitution was carried out both in the A position and in the B position (general formula: Ln₅A(W_{1-y}B_{y})_{1.1}O_{12-δ}), where x=1, y=0.455 or 0.091, z=1.1, and where Ln=La and B=(Mo, Re, U, Cr, Nb).

In particular:

| | | |
|---|---|---|
| La₅NdWMo_{0.1}O_{12-δ}, | La₅NdW_{0.6}Mo_{0.5}O_{12-δ}, | La₅NdWRe_{0.1}O_{12-δ}, |
| La₅NdW_{0.6}Re_{0.5}O_{12-δ}, | La₅NdWU_{0.1}O_{12-δ}, | La₅NdW_{0.6}U_{0.5}O_{12-δ,} |
| La₅NdWCr_{0.1}O_{12-δ}, | La₅NdW_{0.6}Cr_{0.5}O_{12-δ}, | La₅NdWNb_{0.1}O_{12-δ}, |
| La₅NdW_{0.6}Nb_{0.5}O_{12-δ}, | La₅CeWMo_{0.1}O_{12-δ}, | La₅CeW_{0.6}Mo_{0.5}O_{12-δ}, |
| La₅CeWRe_{0.1}O_{12-δ}, | La₅CeW_{0.6}Re_{0.5}O_{12-δ}, | La₅CeWU_{0.1}O_{12-δ}, |
| La₅CeW_{0.6}U_{0.5}O_{12-δ,} | La₅CeWCr_{0.1}O_{12-δ}, | La₅CeW_{0.6}Cr_{0.5}O_{12-δ}, |
| La₅CeWNb_{0.1}O_{12-δ}, | La₅CeW_{0.6}Nb_{0.5}O_{12-δ}, | La₅GdWMo_{0.1}O_{12-δ}, |
| La₅GdW_{0.6}Mo_{0.5}O_{12-δ}, | La₅GdWRe_{0.1}O_{12-δ}, | La₅GdW_{0.6}Re_{0.5}O_{12-δ}, |
| La₅GdWU_{0.1}O_{12-δ}, | La₅GdW_{0.6}U_{0.5}O_{12-δ,} | La₅GdWCr_{0.1}O_{12-δ}, |
| La₅GdW_{0.6}Cr_{0.5}O_{12-δ}, | La₅GdWNb_{0.1}O_{12-δ}, and | La₅GdW_{0.6}Nb_{0.5}O_{12-δ.} |

In addition, bar-shaped samples of Ln₆W_{1.1}O_{1-δ} material, where Ln=La or Nd, which was calcinated for 10 minutes at 900° C. and monoaxially compressed at 100 MPa, were prepared for comparative purposes. The dimensions in the basic state were 40×5×4 mm³. The bar-shaped samples were sintered in air for 4 hours, either at 1150° C. or at 1350° C.

### B. Investigation of the Structure

The structure of materials can be investigated using XRD measurements. The measurements were carried out using an X-ray diffractometer system by the company PANalytical. The X′Pert Pro System in combination with the high-speed detector X′Celerator is operated with a copper X-ray tube in order to generate monochromatic Cu radiation. The XRD patterns were recorded in the 2Teta range between 20° bis 90° and analyzed using the software X′Pert Highscore Plus (PANalytical).

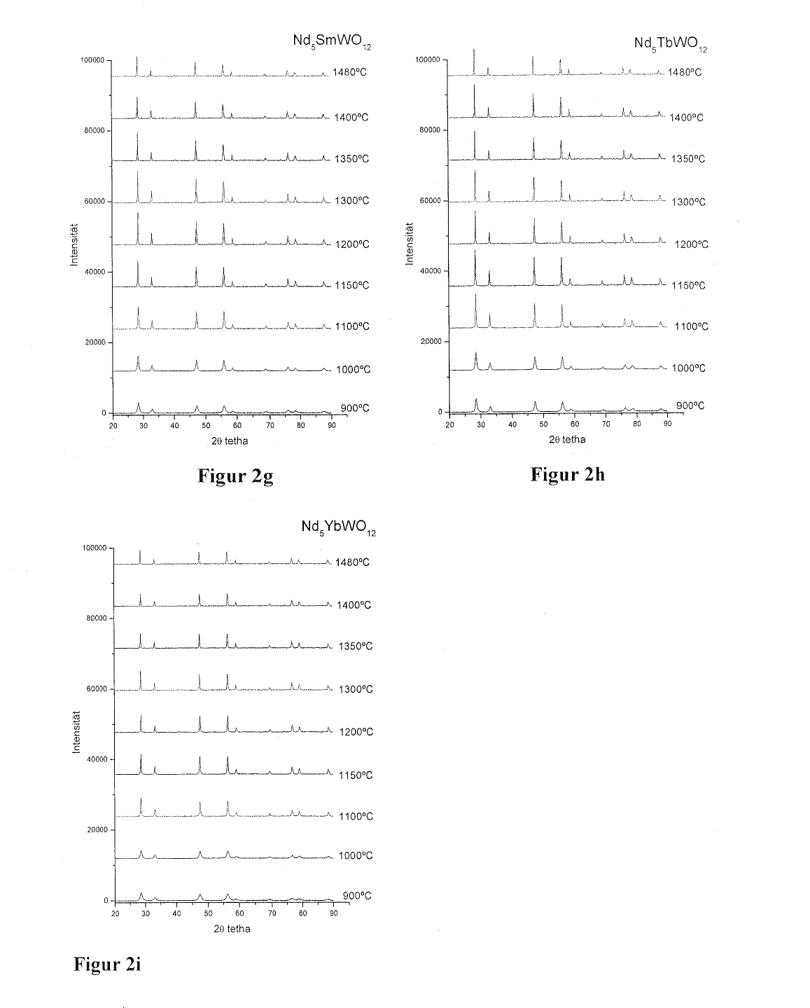

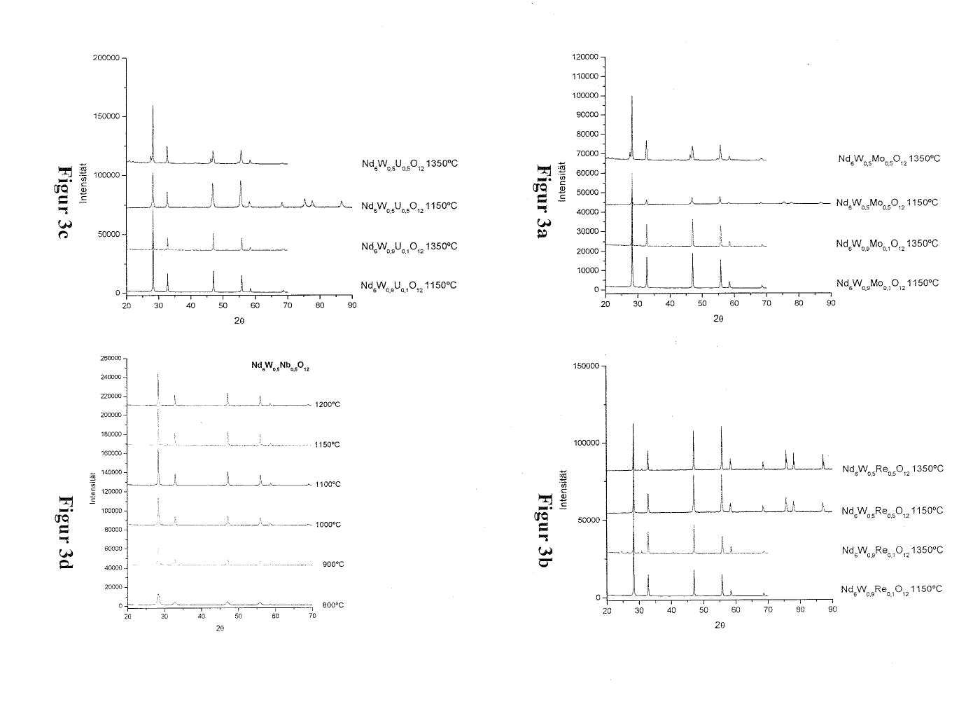

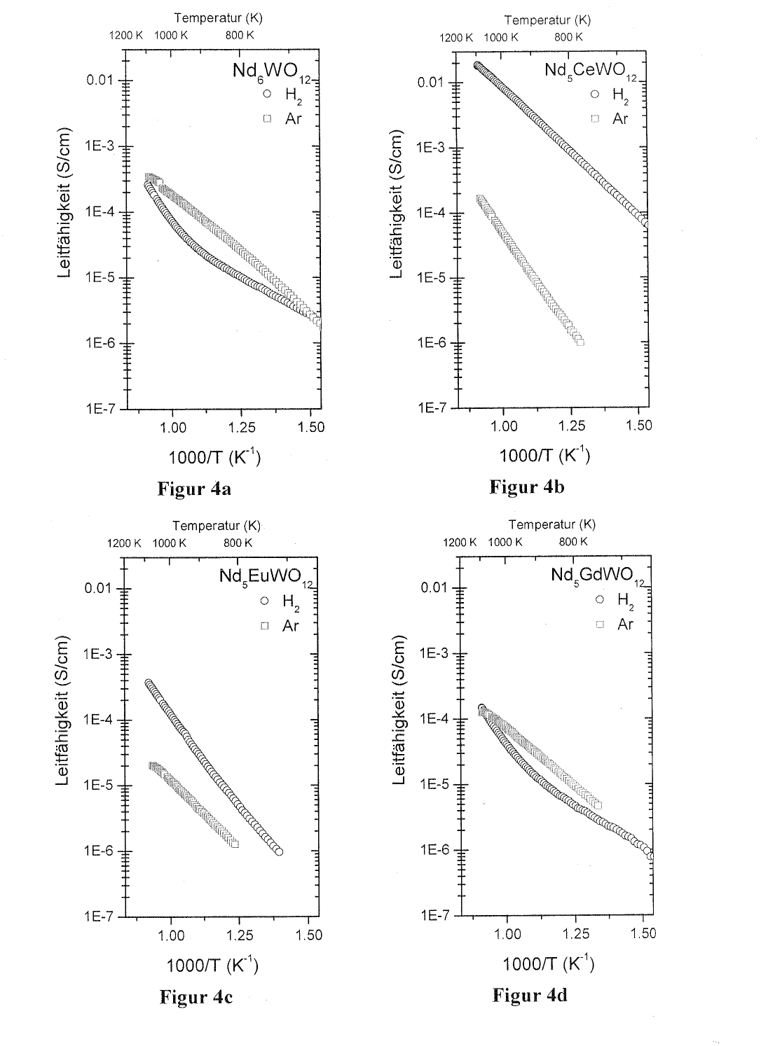

If the materials are heated to different temperatures, changes in the structure due to the temperature can be made visible by comparing the results. FIGS. 2a to 2i and FIGS. 3a to 3d show the results of the structural investigations.

The investigated materials of the aforementioned groups A and B show a fluorite structure (FIGS. 2 and 3). This is an indication for the formation of a proton-conducting phase and the incorporation of the doping elements (A2 and B2) into the oxide lattice.

With the exception of the compound La₆₋ₓZrₓW0₁₂ from [1], a simultaneous incorporation of two or more A position elements and/or two or more B position elements into the generic compound A₆BO₁₂ has so far not been reported in the literature.

### C. Investigation of the Conductivity

The electrical conductivity was determined in a standard manner by means of the four-point method on the sintered rectangular samples. Silver paste and silver wire were used as contacting agents. The measurements took place at different atmospheric conditions, such as under argon and hydrogen, in each case at 20° C. and saturated with water. The constant current was provided by means of a programmable power source (Keithley 2601), whereas the voltage drop over the sample was detected by means of a multimeter (Keithley 3706). In order to exclude thermal effects and avoid non-ohmic responses, the voltage, together with the current, was measured in both directions forwards and backwards.

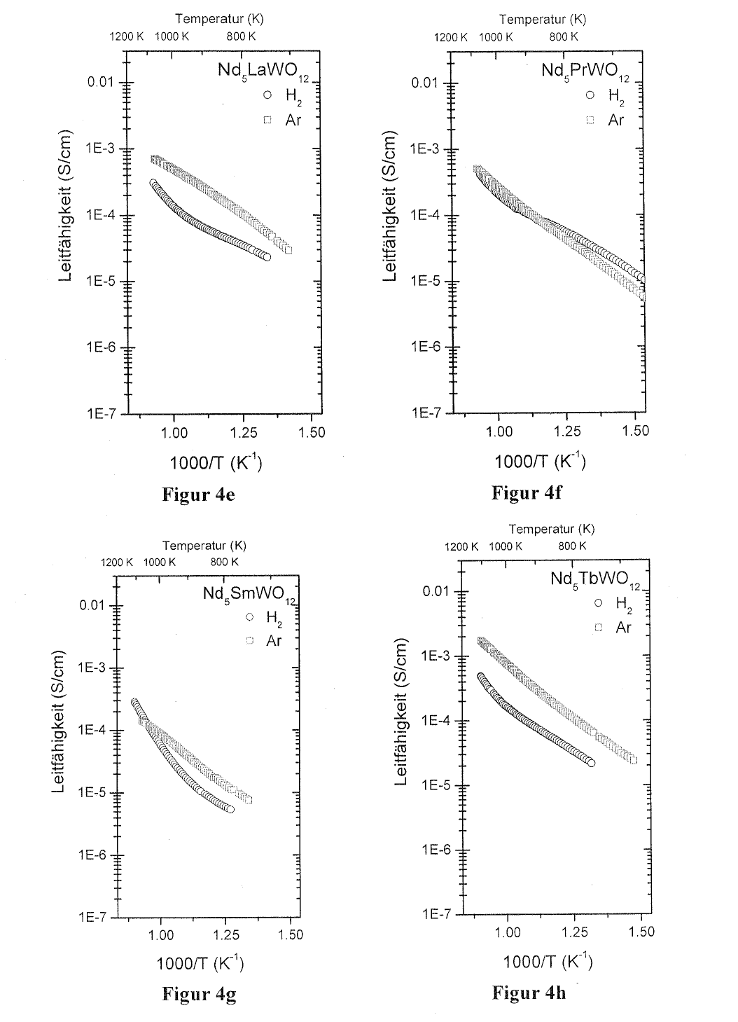

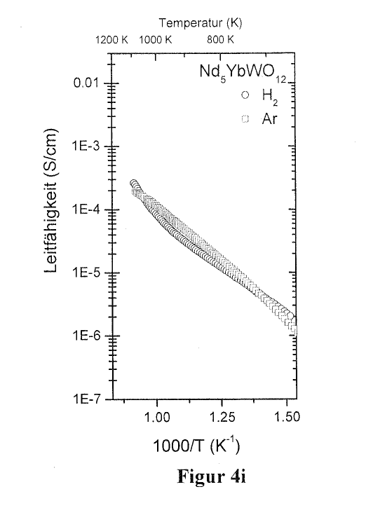

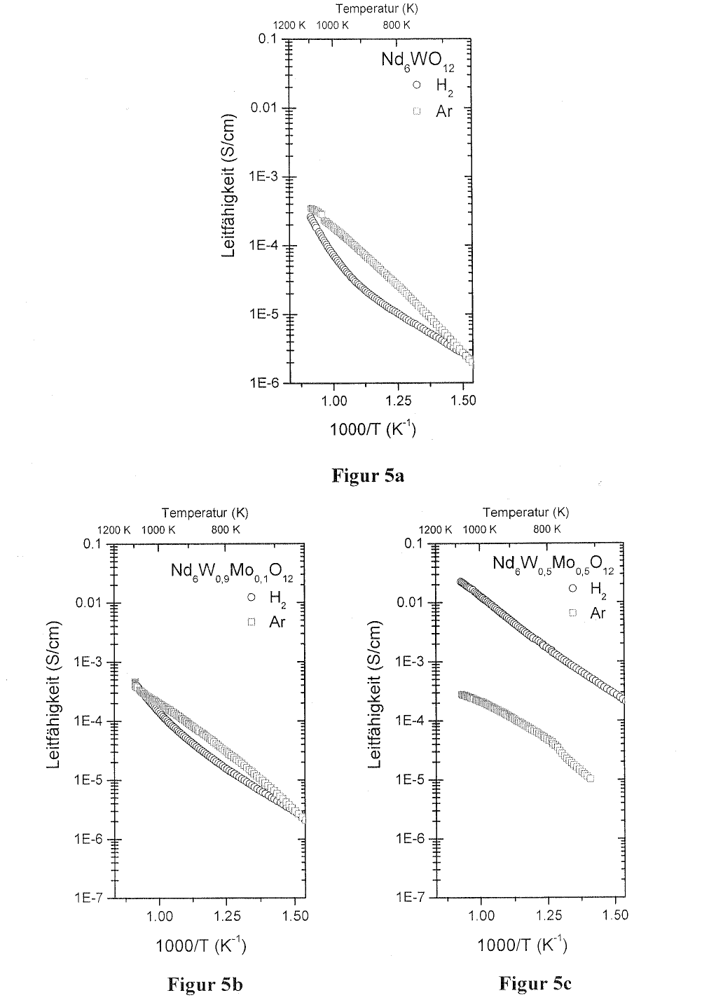

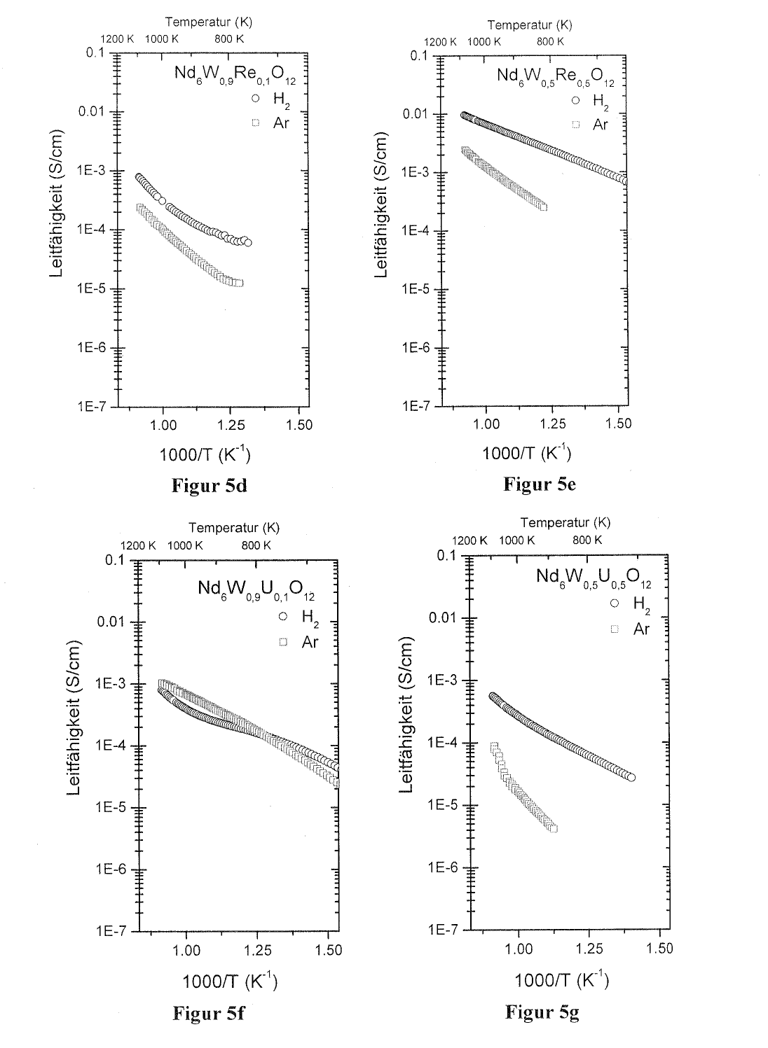

The results of the conductivity tests on the various materials of the above-mentioned A and B groups are apparent from FIGS. 4a to 4i and 5a to 5g. They show the improvement of the total conductivity of the materials according to the invention in a moist argon and hydrogen atmosphere as compared to the non-doped sample consisting of Nd₆W_{1.1}O₁₂.

For illustration purposes, the electrical conductivities of the tested samples at 800° C. in a moist and dry atmosphere are additionally also shown below in a table form. These samples were also sintered at 1350° C.

TABLE 1
Combined ion and electron conductivity measurements on
A position-substituted materials (general formula:
Nd₅AW_{1.1}O_{12-δ}) (from FIG. 4)

| | Argon - 800° C. | Activation | H₂ - 800° C. | Activation |
|---|---|---|---|---|
| | (moist) | energy | (moist) | energy |
| A = | *10⁻⁴ [S · cm⁻¹] | E_{act} [kJ/mol] | *10⁻⁴ [S · cm⁻¹] | E_{act} [kJ/mol] |
| Nd | 2.90 | 57.9 | 2.00 | 115.8 |
| Ce | 1.45 | 116.4 | 167 | 75.6 |
| Eu | 0.20 | 77.2 | 3.22 | 111.9 |
| Gd | 1.22 | 65.6 | 1.18 | 99.2 |
| La | 7.03 | 47.3 | 3.06 | 86.5 |
| Pr | 4.89 | 66.4 | 4.11 | 81.6 |
| Sm | 1.40 | 62.8 | 1.73 | 111.7 |
| Yb | 1.82 | 62.7 | 2.14 | 107.0 |

TABLE 2
Combined ion and electron conductivity measurements on
B position-substituted materials (general formula:
Nd₆(W_{1-y}B_{y})_{1.1}O_{12-δ}) (from FIG. 5)

| | Argon - 800° C. | |
|---|---|---|
| | (moist) | H₂ - 800° C. (moist) |
| | *10⁻⁴ [S cm⁻¹] | *10⁻⁴ [S cm⁻¹] |
| Nd₆(W_{0.9}Re_{0.1})_{1.1}O_{12-δ} | 2.8 | 6.6 |
| Nd₆(W_{0.5}Re_{0.5})_{1.1}O_{12-δ} | 24 | 93 |
| Nd₆(W_{0.5}U_{0.5})_{1.1}O_{12-δ} | 0.61 | 4.7 |
| Nd₆(W_{0.9}U_{0.1})_{1.1}O_{12-δ} | 9.8 | 7.2 |
| Nd₆(W_{0.5}Mo_{0.5})_{1.1}O_{12-δ} | 2.8 | 220 |
| Nd₆(W_{0.9}Mo_{0.1})_{1.1}O_{12-δ} | 3.3 | 3.4 |

### D. Permeability Tests

Measurements on permeability were made with sample slices with a diameter of 15 mm. In this case, the samples respectively consisted of a gas-tight material slice with a thickness of 900 μm that was sintered at 1550° C. Both sides of the slices were coated with a layer consisting of Pt ink (Mateck, Germany) of 20 μm thickness by screen printing, with the aim of improving the superficial hydrogen exchange. The sealing was effected using golden O-rings. The hydrogen was separated from a gas mixture (pH2O=0.025 atm), which was saturated with water at room temperature (T=25° C.), of H₂—He in a mole ratio of 1:1 or 1:5. The entire continuous gas flux of the gas mixture was 120 mL/min and that of the flushing gas argon 180 mL/min.

The hydrogen content in the flushing gas on the permeate side of the membrane was analyzed by means of a gas chromatograph (Varian CP-4900 microGC with Molsieve5A, PoraPlot-Q glass capillary and CP-Sil module) Thus, based on the assumption of the ideal gas law, the hydrogen flux rate can be determined together with the gas flux of the flushing gas.

The permeability results showed a higher permeability of the substituted materials Nd₅EuW_{1.1}O_{12-δ} according to the invention compared to Nd₆W_{1.1}O₁₂.

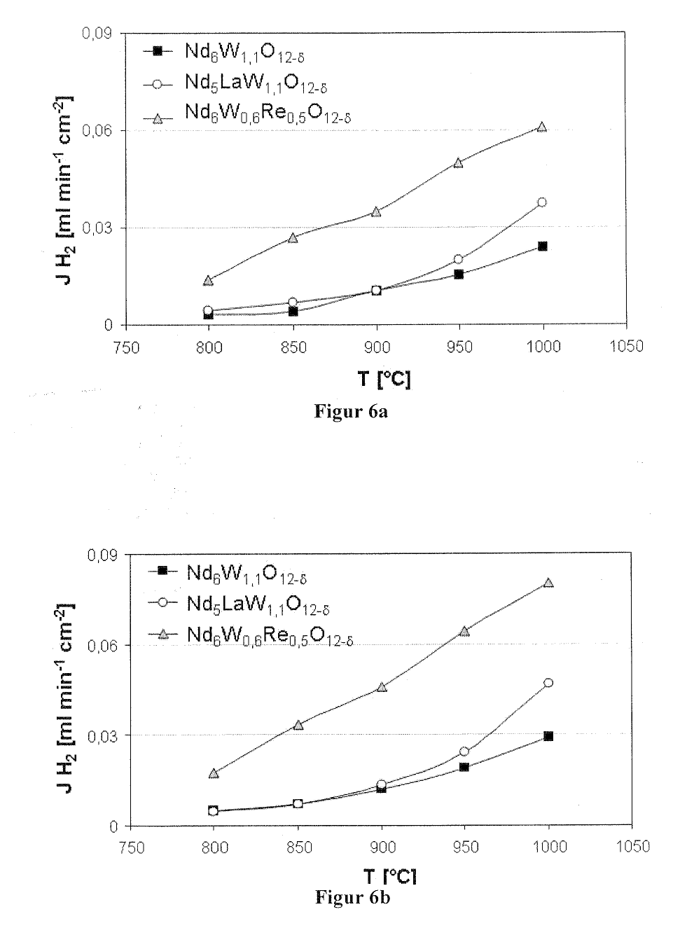

A comparison of the permeability tests for moist H₂ in a testing membrane consisting of an A position-substituted material (Nd₅LaW_{1.1}O_{12-δ}) and an material substituted in the B position (Nd₆W_{0.6}Re_{0.5}O_{12-δ}) with a testing membrane comprising Nd₆W_{1.1}O_{12-δ} is illustrated in the following table (from FIG. 6a with 20% H₂ mixture and from 6b with 50% H₂ mixture).

TABLE 3

| Tem- | J H₂ [ml min⁻¹ cm⁻²] | | | | | |
|---|---|---|---|---|---|---|
| pera- | Nd₆W_{1.1}O_{12-δ} | | | | | |
| ture | (comparison) | | Nd₅LaW_{1.1}O_{12-δ} | | Nd₆W_{0.6}Re_{0.5}O_{12-δ} | |
| [° C.] | 20% H₂ | 50% H₂ | 20% H₂ | 50% H₂ | 20% H₂ | 50% H₂ |
| 1000 | 0.0240 | 0.0292 | 0.0375 | 0.0468 | 0.0608 | 0.0802 |
| 950 | 0.0153 | 0.0191 | 0.0200 | 0.0243 | 0.0499 | 0.0642 |
| 900 | 0.0105 | 0.0119 | 0.0105 | 0.0134 | 0.0350 | 0.0459 |
| 850 | 0.004 | 0.007 | 0.00683 | 0.00704 | 0.02686 | 0.03325 |
| 800 | 0.003 | 0.005 | 0.00442 | 0.00467 | 0.01392 | 0.01752 |

The material Nd₆W_{0.6}Re_{0.5}O_{12-δ} substituted in the B position currently exhibits the best hydrogen permeability values (see Table 3) and is thus particularly advantageously suitable for use as a mixed proton-electron conducting membrane in a pre-combustion power plant. In addition to its good hydrogen permeability, it exhibits a high mixed conductivity and is characterized by a good chemical resistance to aggressive atmospheres as well as by its good durability. Particular emphasis must be placed on the fact that these properties are present in this material already at moderate temperatures around 800° C. For example, the hydrogen flux through a membrane consisting of Nd₆W_{0.6}Re_{0.5}O_{12-δ} (B position substitution), even at 800° C., is already 3 to 4 times that of a membrane consisting of Nd₆W_{1.1}O_{12-δ} (also B position substituted).

### LITERATURE CITED IN THE APPLICATION

[1] Shimura T., Fujimoto S., Iwahara H., Solid State Ionics 2001, 143 (1), 117-123.
[2] Haugsrud R, Solid State Ionics 2007, 178, pages 555-560.
[3] Yoshimura M., Baumard, J. F., Materials Research Bulletin, Volume 10, Issue 9, September 1975, pages 983-988.

1. A mixed proton-electron conducting material, which is present in a defect fluorite structure and in the water-free state has the following composition:
(Ln₁₋ₓAₓ)₆(W_{1-y}B_{y})_{z}O_{12-δ}
where
Ln=an element from the group (La, Pr, Nd, Sm),
A=at least one element from the group
(La, Ce, Pr, Nd, Eu, Gd, Tb, Er, Yb, Ca, Mg, Sr, Ba, Th, In, Pb),
B=at least one element from the group (Mo, Re, U, Cr, Nb),
0≦x≦0.7 and 0≦y≦0.5, wherein, however, either x or y>0,
1.00≦z≦1.25 and 0≦d≦0.3.

2. The mixed proton-electron conducting material according to claim 1, where 0≦x≦0.5.

3. The mixed proton-electron conducting material according to claim 1, with the composition (Ln₁₋ₓAₓ)₆W_{z}O_{12-δ}, where x>0 and y=0.

4. The mixed proton-electron conducting material according to claim 3, with the composition (Ln₅A)₆W_{z}O_{12-δ}.

5. The mixed proton-electron conducting material according to claim 3, with the composition (Ln₁₋ₓAₓ)₆W_{1.1}O_{12-δ}, where z=1.1.

6. The mixed proton-electron conducting material according to claim 3, where Ln=La or Nd.

7. The mixed proton-electron conducting material according to claim 3, where A=at least one element from the group (La, Ce, Eu, Gd, Tb, Sm, Pr or Yb).

8. The mixed proton-electron conducting material according to claim 1 with the composition:

| | | | |
|---|---|---|---|
| Nd₆W_{1.1}O_{12-δ}, | Nd₅LaW_{1.1}O_{12-δ}, | Nd₅CeW_{1.1}O_{12-δ}, | Nd₅PrW_{1.1}O_{12-δ,} |
| Nd₅SmW_{1.1}O_{12-δ}, | Nd₅EuW_{1.1}O_{12-δ}, | Nd₅GdW_{1.1}O_{12-δ}, | Nd₅TbW_{1.1}O_{12-δ,} |
| Nd₅YbW_{1.1}O_{12-δ,} | La₅EuW_{1.1}O_{12-δ}, | La₅CeW_{1.1}O_{12-δ} or | La₅TbW_{1.1}O_{12-δ}. |

9. The mixed proton-electron conducting material according to claim 1, with the composition Ln₆(W_{1-y}B_{y})_{Z}O_{12-δ}, where x=0 and y>0.

10. The mixed proton-electron conducting material according to claim 9, with the composition Ln₆WB_{0.1}O_{12-δ} or Ln₆W_{0.6}B_{0.5}O_{12-δ}, where in each case z=1.1.

11. The mixed proton-electron conducting material according to claim 9, with the composition Ln₆(W_{1-y}B_{y})_{1.1}O_{12-δ}, where z=1.1.

12. The mixed proton-electron conducting material according to claim 9, where Ln=La or Nd.

13. The mixed proton-electron conducting material according to claim 9, where B=at least one element from the group (Mo, Re, U, Cr, Nb).

14. The mixed proton-electron conducting material according to claim 9, with the composition:

| | | |
|---|---|---|
| Nd₆WMo_{0.1}O_{12-δ,} | Nd₆W_{0.6}Mo_{0.5}O_{12-δ}, | Nd₆WRe_{0.1}O_{12-δ}, |
| Nd₆W_{0.6}Re_{0.5}O_{12-δ}, | Nd₆WU_{0.1}O_{12-δ}, | Nd₆W_{0.6}U_{0.5}O_{12-δ,} |
| Nd₆WCr_{0.1}O_{12-δ}, | Nd₆W_{0.6}Cr_{0.5}O_{12-δ}, | Nd₆WNb_{0.1}O_{12-δ}, |
| Nd₆W_{0.6}Nb_{0.5}O_{12-δ}, | La₆WMo_{0.1}O_{12-δ}, | La₆W_{0.6}Mo_{0.5}O_{12-δ}, |
| La₆WRe_{0.1}O_{12-δ}, | La₆W_{0.6}Re_{0.5}O_{12-δ}, | La₆WU_{0.1}O_{12-δ}, |
| La₆W_{0.6}U_{0.5}O_{12-δ,} | La₆WCr_{0.1}O_{12-δ}, | La₆W_{0.6}Cr_{0.5}O_{12-δ}, |
| La₆WNb_{0.1}O_{12-δ} or | La₆W_{0.6}Nb_{0.5}O_{12-δ.} | |

15. The mixed proton-electron conducting material according to claim 1, with the composition La₅A(W_{1-y}B_{y})_{1.1}O_{12-δ}, where Ln=La and z=1.1.

16. The mixed proton-electron conducting material according to claim 15, with the composition:

| | | |
|---|---|---|
| La₅NdWMo_{0.1}O_{12-δ}, | La₅NdW_{0.6}Mo_{0.5}O_{12-δ}, | La₅NdWRe_{0.1}O_{12-δ}, |
| La₅NdW_{0.6}Re_{0.5}O_{12-δ}, | La₅NdWU_{0.1}O_{12-δ}, | La₅NdW_{0.6}U_{0.5}O_{12-δ,} |
| La₅NdWCr_{0.1}O_{12-δ}, | La₅NdW_{0.6}Cr_{0.5}O_{12-δ}, | La₅NdWNb_{0.1}O_{12-δ}, |
| La₅NdW_{0.6}Nb_{0.5}O_{12-δ}, | La₅CeWMo_{0.1}O_{12-δ}, | La₅CeW_{0.6}Mo_{0.5}O_{12-δ}, |
| La₅CeWRe_{0.1}O_{12-δ}, | La₅CeW_{0.6}Re_{0.5}O_{12-δ}, | La₅CeWU_{0.1}O_{12-δ}, |
| La₅CeW_{0.6}U_{0.5}O_{12-δ,} | La₅CeWCr_{0.1}O_{12-δ}, | La₅CeW_{0.6}Cr_{0.5}O_{12-δ}, |
| La₅CeWNb_{0.1}O_{12-δ}, | La₅CeW_{0.6}Nb_{0.5}O_{12-δ}, | La₅GdWMo_{0.1}O_{12-δ}, |
| La₅GdW_{0.6}Mo_{0.5}O_{12-δ}, | La₅GdWRe_{0.1}O_{12-δ}, | La₅GdW_{0.6}Re_{0.5}O_{12-δ}, |
| La₅GdWU_{0.1}O_{12-δ}, | La₅GdW_{0.6}U_{0.5}O_{12-δ,} | La₅GdWCr_{0.1}O_{12-δ}, |
| La₅GdW_{0.6}Cr_{0.5}O_{12-δ}, | La₅GdWNb_{0.1}O_{12-δ}, or | La₅GdW_{0.6}Nb_{0.5}O_{12-δ.} |

17. A gas-tight, hydrogen-permeable membrane, comprising a mixed proton-electron conducting material according to claim 1, for the separation of hydrogen from a gas mixture.

18. An electrolyte for a high-temperature fuel cell, comprising a mixed proton-electron conducting material according to claim 1.
